(19) United States
(12) Patent Application Publication
(10) Pub. No.: US 2009/0128977 A1
(43) Pub. Date: May 21, 2009

(54) Method to protect Ethernet connected products

(76) Inventor: Soren Kjaerulff Christensen, Struer (DK)

Correspondence Address: JAMES C. WRAY, 1493 CHAIN BRIDGE ROAD, SUITE 300, MCLEAN, VA, 22101, US

(21) Appl. No.: 12/313,658

(22) Filed: Nov. 21, 2008

(30) Foreign Application Priority Data
Nov. 21, 2007 (DK) PA 2007 01659

(51) Int. Cl. H02H 3/22

(52) U.S. Cl. 361/111

(57) ABSTRACT

The present invention relates to a method for protecting electronic products, which electronic product comprises an Ethernet connector, where the Ethernet connector comprises a protection circuit, which circuit comprises at least one capacitor and at least one resister, where the Ethernet connector is used to protect against high energy transients, where the Ethernet connector comprises a protection circuitry. Where the Ethernet connector comprises a protection circuitry, which protection circuitry is characterized in that in the protection circuitry is the electrically product ground and Ethernet ground connected by at least a VDR (Voltage Dependant Resistor), which VDR is connected between the Ethernet ground and the product ground in the protection circuitry.

### FIELD OF THE INVENTION

The present invention relates to a method for protecting electronic products, which electronic product comprises an Ethernet connector, where the Ethernet connector comprises a protection circuit, which circuit comprises at least on capacitor and at least one resister, where the Ethernet connector is used to protect against high energy transients, where the Ethernet connector comprises a protection circuitry.

### BACKGROUND OF THE INVENTION

EP0886361 concerns an electrostatic discharge (ESD) damage prevention device comprises a spark gap coupled in series with a high-impedance network with a first node of the series combination of the spark gap and high-impedance network coupled to a conductive location that may be subject to an electrostatic discharge and the second node coupled to a conductor capable of conducting away charge delivered by an ESD event. The spark gap defines the level of electrical isolation and the high-impedance network controls dissipation of charge delivered by an ESD event.

### OBJECT OF THE INVENTION

The object of the invention is to use a VDR (Voltage Dependant Resistor) to protect the transformer and further the use of a double shield connector modified to constitute partly or all of the capacitance needed across the VDR.

### DESCRIPTION OF THE INVENTION

The object can be fulfilled by a method as described in claim 1 where a protection circuitry is arranged between the electronic products' ground and Ethernet connectors' ground, where said circuitry is connected by at least a capacitor and at least a VDR (Voltage Dependant Resistor), which VDR is connected between the Ethernet connectors ground and the electronic products ground in the protection circuitry.

A method as described above can be used to protect the electronics in an Ethernet connector and to protect the electronics in products, where the connector is used to protect against high energy transients like lightning/sparks and to make a connector EMC architecture that is optimised to class 2 products. By placing the shielding circuit in the connector and as such outside the electronic circuit, it can be achieved that electrical high voltage sparks (surges) are eliminated outside the electronic circuit. By placing the protection circuit as far as way from the printed board in the electric circuit, there is a security that high voltage sparks (surges) will be eliminated before these sparks (surges) reach e.g. any ground connectors. High voltage sparks can be generated in all external circuits that have to be connected. E.g. a hand-held equipment which is connected by an Ethernet connector can have a static charge of several thousand volts. That high charge is able to generate sparks that can destroy semiconductors in a device. It is therefore very important before interconnecting electric circuits that they are protected or that that they are discharged, for example by being connected to a common ground before they are interconnected. By using a voltage dependent resistor, it is possible to increase the resistance as soon as the voltage is increasing. The VDR will in this way already in the Ethernet connector eliminate high voltage sparks (surges) before they get access into an electronic circuit.

In this context it is envisioned that both male and female Ethernet connectors are suitable to be improved by the inventive protection circuitry. Ethernet connectors as will be understood from the description, may both be in the shape of connectors per se, but also be connections having these properties, for example integrated into other equipment or as a separate product.

Two shields or plates arranged between the Ethernet connectors ground and the electronic products ground forms part of or all the capacitance needed. High voltage sparks normally only exists for very short periods, at least if they are the result of static charge. Therefore, even small capacitors can perform an effective shielding. In the Ethernet connector it is possible to form two metal shields with isolation there between and in this way form a small capacitor directly into the connector housing. This is rather effective because in the Ethernet connector there is only limited room for components. If e.g. one capacitor can be formed directly in the connector housing, this component does not take further space in the connector.

At least one VDR and at least one capacitor is connected between an electronic products ground and a Ethernet connectors ground, which VDR and capacitor can be integrated into said Ethernet connector. By integrating the protection circuit into the Ethernet connector, the protection circuit is always in place each time an Ethernet connector according to the invention is used.

A protection circuit can be integrated into an electronic product which in turn is connectable to an Ethernet connector. In this alternative embodiment it is also possible to place the protection circuit integrated in the product. This can preferably be made just behind the Ethernet connection as a separate circuit which is not directly connected to a printed circuit in the electronic apparatus.

A protection circuitry is used to protect the electronic circuitry in electronic products, where the protection circuitry comprises at least one VDR and at least one capacitor, where said VDR and at least said one capacitor is connected between an electronic products ground and an Ethernet connectors ground, which VDR and capacitor is integrated into an Ethernet connector.

Alternatively, the protection circuitry is integrated into the electronic product.

Gas field resistors and series capacitors are components that can be used in the protection circuit in order to provide additional protection.

The protection circuitry may be installed in many positions/places in the circuitry, but particularly two areas of the installation are preferred:
1. The protection of the resistors that terminates the Ethernet cable. The resistors are protected with gas field resistors and a series capacitor. The capacitors make the voltage over the arrestor increase with a moderate current that don't destroy the resistor. If the capacitor is not present the resistor has to handle a much higher energy.
2. The protection of the two transformers. The transformer primary to secondary insulation is protected with a VDR (Voltage Dependant Resistor) that can handle the current in the transients that have to be handled.

The invention is also directed to an Ethernet connector as such, where the Ethernet connector is used in a method as described above. The connector incorporates an inventive circuitry as described above in order to avoid the voltage differences causing damage. The Ethernet connector may be arranged in the electronic product, or alternatively in the connector on a cable, usually in the distal end of a cable.

### DESCRIPTION OF THE DRAWING

FIG. 1 is an example where the invention is embedded into an Ethernet connector.

FIG. 2 shows a circuit which circuit comprises an internal high voltage ground protection.

### DETAILED DESCRIPTION OF THE INVENTION

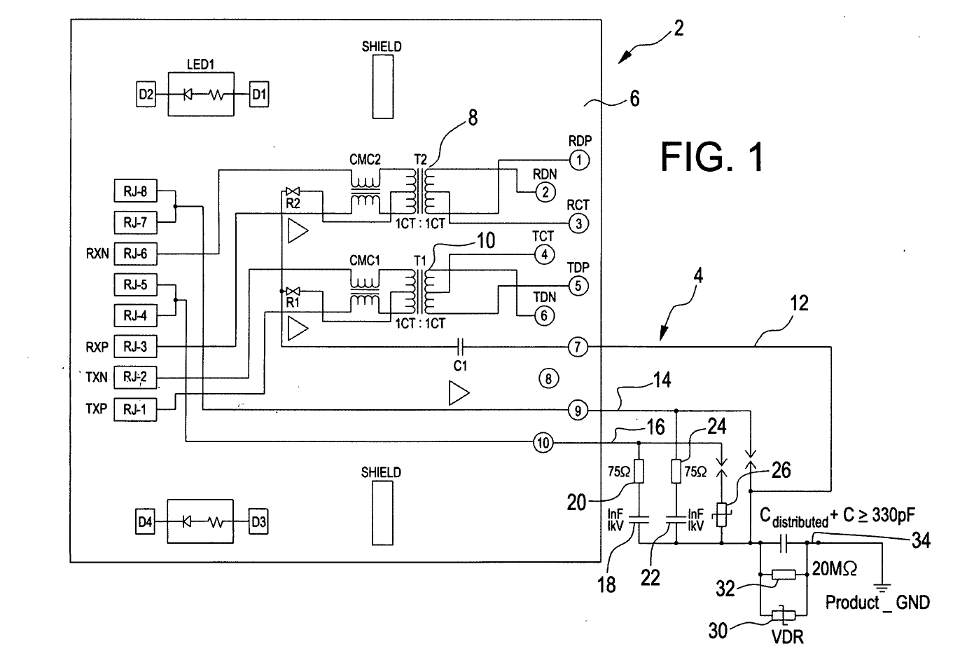

FIG. 1 shows an electric circuit 2 which is connected to an Ethernet connection 4 where the electric circuit comprises a shield 6 and the electric circuit comprises shielding transformers 8 and 10. A ground line 12 is connected into the connector housing 4 which connector housing further comprises electric connections over line 14 and 16. The line 16 is connected through a resistor 20 and a capacitor 18 to the ground. Further is the line 14 connected thorough a resistor 24 and a capacitor 22 to the ground. Further is the line 16 connected through a variable resistor 26. The line 12 together with the ground connected to the capacitor 18, 22 and variable capacitor 26 is connected through the VDR (voltage depending resistor) 30. This VDR resistor is coupled parallel to a resistor 32. To both these resistors 30 and 32, the external ground 34 are connected.

It is to be understood that any high voltage sparks transmitted over the external ground terminal 34 will reach the VDR resistor which immediately increase the resistance so that high voltage sparks are eliminated.

FIG. 1 is an example where the invention is embedded into an Ethernet connector. The first connector is made with an extra shield. The outer shield is the product ground (GND) and can be connected directly to ground in the product. The inner ground is here called Ethernet ground and is disconnected to the product ground by two transformers, a VDR, a resistor and a capacitor.

The capacitor can partly or totally be made by the capacitance between the two shields. The two shields and the VDR are different from a normal Ethernet connector, where Ethernet ground and product ground is connected in the product. By keeping the two grounds disconnected the leakage current from other products is limited.

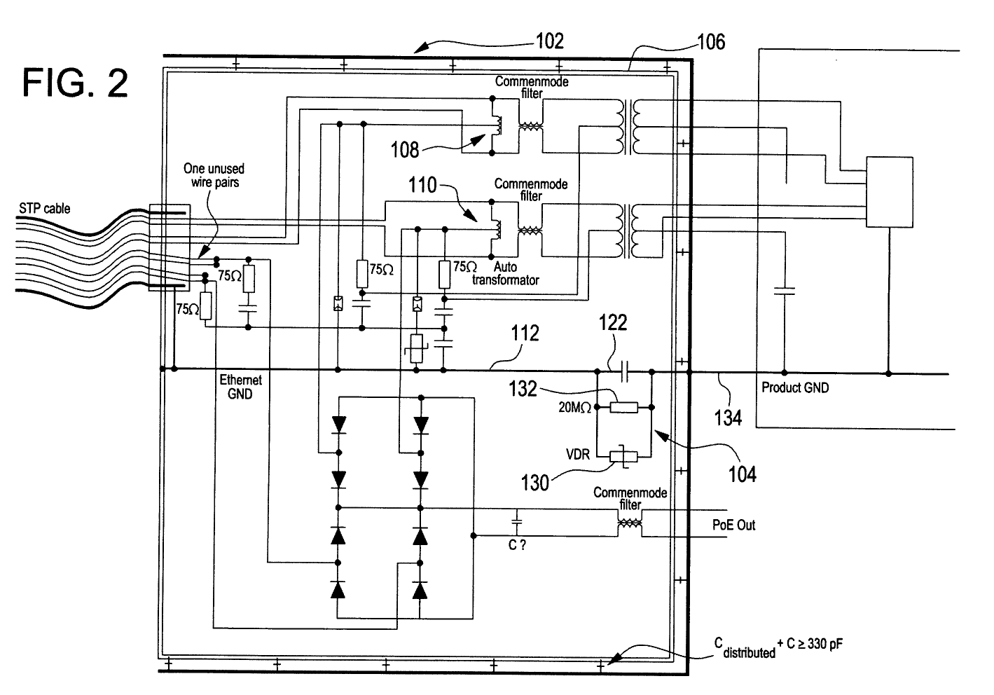

FIG. 2 shows a circuit 102 which circuit 102 comprises an internal high voltage ground protection 104. A shield 106 is shown connected by means of capacitors to an external shield where common mode filters 108 and 110 is used for filtration of input signals. The internal ground line 112 is connected towards the VDR 130 and the fixed resistor 132 and to a capacitor 122 towards the product ground 134. It is to be understood that the circuit 104 could be placed as part of the receiving connector. But in some situations this connector can be placed inside the circuit.

FIG. 2 is an example where a standard connector is used and extra components outside the connector is added. These extra components can protect the transformer and resistors in the connector against transients. They further make it possible to have an Ethernet ground and a product ground which are not connected.

1. A method for protecting electronic products, which electronic product comprises an Ethernet connector, where said electronic product and said Ethernet connector has respective grounds, where said Ethernet connector comprises a protection circuitry, which protection circuitry comprises at least on capacitor and at least one resistor, where said Ethernet connector is used to protect against high energy transients, wherein said electronic product's ground and said Ethernet connectors ground are connected by at least a VDR (Voltage Dependant Resistor), which VDR is connected between said Ethernet ground and said electronic products ground in the protection circuitry.

2. A method according to claim 1, where two shields or plates arranged between said Ethernet connectors ground and said electronic products ground forms part of or all of the capacitance needed.

3. A protection circuitry for use in a method according to claim 1 comprising at least on VDR and at least one capacitor, where said VDR and at least said one capacitor is connected between an electronic products ground and an Ethernet connectors ground, which VDR and capacitor is integrated into an Ethernet connector.

4. A protection circuitry for use in a method according to claims 1, where said circuitry is integrated into an electronic product connectable to an Ethernet connector.

5. A protection circuitry according to claim 3 wherein gas field resistors and series capacitors are further integrated into said protection circuitry.

6. Ethernet connector, where said Ethernet connector incorporates a protection circuitry according to claim 3.

7. Ethernet connector according to claim 6, where said Ethernet connector is integrated into an electronic product.

8. Ethernet connector according to claim 6, where said Ethernet connector is arranged at a distal end of a cable used for connecting with electronic products.
